(19) United States
(12) Patent Application Publication
(10) Pub. No.: US 2026/0117915 A1
(43) Pub. Date: Apr. 30, 2026

(54) JACK STAND

(71) Applicant: ROADTEK ENTERPRISES INC., Blaine, WA (US)

(72) Inventors: Dustin NIELSON, Sedro Wolley, WA (US); Maggie HU, Vancouver BC (CA)

(73) Assignee: ROADTEK ENTERPRISES INC., Blaine, WA (US)

(21) Appl. No.: 18/929,143

(22) Filed: Oct. 28, 2024

(51) Int. Cl. F16M 11/00

(52) U.S. Cl. CPC F16M 11/00; F16M 2200/028

(57) ABSTRACT

A jack stand is disclosed herein that may include a base with a channel, and an elongated saddle post at least partially inserted into the channel, the elongated saddle post having at least one slot. The jack stand may further include a pawl at least partially rotatable around an axis to engage with the at least one slot of the elongated saddle post, and a knob assembly attached to the pawl and centered along the axis of the pawl, the knob assembly including a knob and a torsion spring to bias at least a portion of the pawl into the slot.

### FIELD

The present disclosure generally relates to load bearing devices, in particular to jack stands for supporting the weight of a heavy object, such as a vehicle.

### BACKGROUND

A jack stand is a mechanical device used to support the weight of a heavy object, such as a motor vehicle, in an elevated or lifted position after the heavy object has already been lifted by another device such as a jack. When the object needs to be lowered, the jack is once again used to lower the heavy object. Thus, jack stands are not used to lift or lower the heavy object, but instead, only used to keep the object in the lifted position.

The basic design and structure of most jack stands have remained relatively the same for many decades. Most jack stands will typically have a base structure, a saddle post with a saddle at the top of the saddle post that can be raised manually from the base structure to the bottom of the heavy object to be supported by the jack stand, and a handle that serves two functions, one as a carrying handle to lift and carry the jack stand, and the other function for releasing the saddle post so that it can drop down once the jack stand is no longer needed for holding up the heavy object.

FIG. 1 is an example prior art jack stand with features and characteristics that are common to many, if not most, current jack stands. The jack stand 10 includes a base structure 20 (hereinafter simply “base 20”). Disposed at least partly in the base 20 is a saddle post 30 with a saddle 34 at the top of the saddle post 30, and teeth with slots between the teeth on one side of the saddle post 30 as illustrated in FIG. 1. Although not illustrated in FIG. 1, disposed within the base 20 is a pawl that is used to engage with the teeth or slots of the saddle post 30 so that the saddle post 30 remains spatially in place when supporting the heavy object. As noted above, the jack stand 10 may further include a handle 40 that serves two functions, one as a carrying handle to lift and carry the jack stand, and the other function for releasing the saddle post so that it can drop down.

The saddle post 30 may be raised manually when a user pulls the saddle post 30 out of the base 20 until, for example, the saddle 34 contacts the bottom of the heavy object to be supported by the jack stand 10. When the jack stand 10 is no longer needed to support the weight of the heavy object, the handle 40 may be used to disengage the pawl from a slot of the saddle post 30. The use of a handle to disengage the pawl in conventional jack stands made sense when jack stands were initially being developed because of the heavy materials that components of jack stands are typically made of and the leverage that a handle can provide in disengaging the pawl. When the handle 40, which is connected to the pawl is in the “down” position, the pawl will be engaged with one of the slots of the saddle post 30. On the other hand, when the handle 40 is in the “up” position, the pawl will not be engaged with any of the slots of the saddle post 30 (in FIG. 1, the handle 40 is in the middle position), which allows the saddle post 30 to be dropped. Because of the weight of the handle, the position of the handle 40 will normally be in the down position, thus urging the pawl to be engaged with one of the slots of the saddle post 30.

Another feature that is common to most, if not most, jack stands is the inclusion of a tab 50 at the upper end of the base 20 and a recess 31 on the saddle post 30 that extends longitudinally along one side of the saddle post 30. The tab 50, when bent inward by a user, is inserted into the recess 31 of the saddle post 30, thus preventing the saddle post 30 from being accidentally pulled out completely from the base 20.

Unfortunately, these features of many current jack stands have certain shortcomings. For example, with the respect to the handle 40 being used to disengage the pawl from a slot of the saddle post 30, because of the size of the handle 40, it is susceptible to being accidentally moved, thus causing the pawl to disengage from a slot of the saddle post 30 resulting in the saddle post 30 and the saddle 34 dropping, which could result in injuries. Also, because of the leverage that the handle 40 provides, the accidental disengagement of the pawl from a slot of the saddle post 30 is elevated even when there is a load on the jack stand 10. To address this problem, some jack stands are equipped with a pin to insert through the pawl or a slot of the saddle post 30 to prevent the pawl from accidentally disengaging from the saddle post 30. However, this solution has proven to be ineffective at times when the pin is lost, or the user forgets to use the pin during operation of the jack stand 10. As for tab 50, given that the tab 50 is commonly made of the same heavy-duty material (e.g., steel, cast iron, etc.) that the rest of the base 20 is made of, users have found that such a tab 50 is extremely difficult to bend for proper use as a stopper to prevent the saddle post 30 from being accidentally pulled out of the base 20.

### SUMMARY

Varius embodiments of the present disclosure provide for a jack stand. In some embodiments, a jack stand may include a base with a channel, and an elongated saddle post at least partially inserted into the channel, the elongated saddle post having at least one slot. The jack stand may further include a pawl at least partially rotatable around an axis to engage with the at least one slot of the elongated saddle post, and a knob assembly attached to the pawl and centered along the axis of the pawl, the knob assembly including a knob and a torsion spring to bias at least a portion of the pawl into the slot.

In some embodiments, the base includes a top neck portion and a bottom base portion with a flat bottom rim, and the channel at least partially in the top neck portion. In some embodiments, the jack stand further comprises a locking pin and a chain having a first chain end and a second chain end, the locking pin to insert into a slot of the elongated saddle post via holes of the top neck portion of the base and having a first end and a second end opposite of the first end, the first chain end of the chain attached to the first end of the locking pin and the second chain end of the chain attached to a safety pin to attach to the second end of the locking pin. In some embodiments, the elongated saddle post includes a recess on a side of the elongated saddle post, the top neck portion of the base includes a hole, and the jack stand further includes a stopper post to insert through the hole and into the recess of the saddle post. In some embodiments, the stopper post is a screw.

In some embodiments, the elongated saddle post includes a plurality of slots. In some embodiments, the elongated saddle post includes a plurality of teeth arranged longitudinally along a side of the elongated saddle post, and each of the plurality of slots defined by a pair of teeth of the plurality of teeth.

In some embodiments, the elongated saddle post includes a saddle disposed at an end of the elongated saddle post that extends out of the base.

In some embodiments, the knob assembly includes a knob shaft, the knob shaft inserted through the axis of the pawl and attached to the pawl, and the knob disposed at an end of the knob shaft. For these embodiments, the torsion spring may have a central axis that corresponds to the axis of the pawl and has two opposite ends, the two opposite ends inserted into two spring end receiver cavities located on opposite sides of the pawl. In some embodiments, the torsion spring is a double torsion spring with two coils that are disposed on the opposite sides of the pawl, and that wrap around the knob shaft.

In some embodiments, the knob may be a fluted knob. In alternative embodiments, the knob may be a round thumb knob with multiple grooves, a lobe knob, a wing knob, a t-handle knob, or a tapered knob.

In various embodiments, a jack stand assembly is disclosed that includes a saddle post at least partially inserted into a channel of a base, the saddle post having a plurality of slots arranged longitudinally along one side of the saddle post. The jack stand assembly also includes a pawl at least partially rotatable around an axis to engage with one of the plurality of slots of the saddle post, and a knob connected to the pawl through a knob shaft disposed along the axis of the pawl, the knob shaft connecting the knob to the pawl to at least partially rotate the pawl to engage or disengage with the one of the plurality of slots when the knob is rotated.

In some embodiments, the jack stand assembly further comprises the base, the base includes a top neck portion and a bottom base portion, and the channel of the base at least partially in the top neck portion, and wherein the saddle post includes a recess on a side of the saddle post, the top neck portion of the abase includes a hole, and the jack stand further includes a stopper post to insert through the hole and into the recess. In some embodiments, the stopper post is a screw. In some embodiments, the jack stand assembly further comprises a locking pin and a chain having a first chain end and a second chain end, the locking pin to insert into a slot of the saddle post via holes of the top neck portion of the base and having a first end and a second end opposite of the first end, the first chain end of the chain attached to the first end of the locking pin and the second chain end of the chain attached to a safety pin to attach to the second end of the locking pin.

In some embodiments, the jack stand assembly may further comprise a double torsion spring to bias at least a portion of the pawl to engage with the one of the plurality of slots of the saddle post, the double torsion spring includes two coils that are disposed on opposite sides of the pawl and wrap around the knob shaft. In some embodiments, the double torsion spring has two opposite ends that are inserted into two spring end receiver cavities located on opposite sides of the pawl. In some embodiments, the knob of the jack stand assembly may be a fluted knob.

### BRIEF DESCRIPTION OF THE DRAWINGS

FIG. 1 is an example prior art jack stand.

FIG. 2 is a right side view of an example jack stand according to some embodiments.

FIG. 3 is a front view of the example jack stand of FIG. 2 according to some embodiments.

FIG. 4 is a left side view of the example jack stand of FIG. 2 according to some embodiments.

FIG. 5 is a cross-sectional view of the example jack stand of FIG. 2 according to some embodiments.

FIG. 6 is a close-up cross-sectional view of a stopper post inserted into a top neck portion of a base of the jack stand of FIG. 2 according to some embodiments.

FIG. 7A is a close-up view of one of the lateral sides of the pawl of the example jack stand of FIG. 2 according to some embodiments.

FIG. 7B is a top view of the pawl and torsion spring of the example jack stand of FIG. 2 according to some embodiments.

FIG. 8 is an exploded view of the example jack stand of FIG. 2 according to some embodiments.

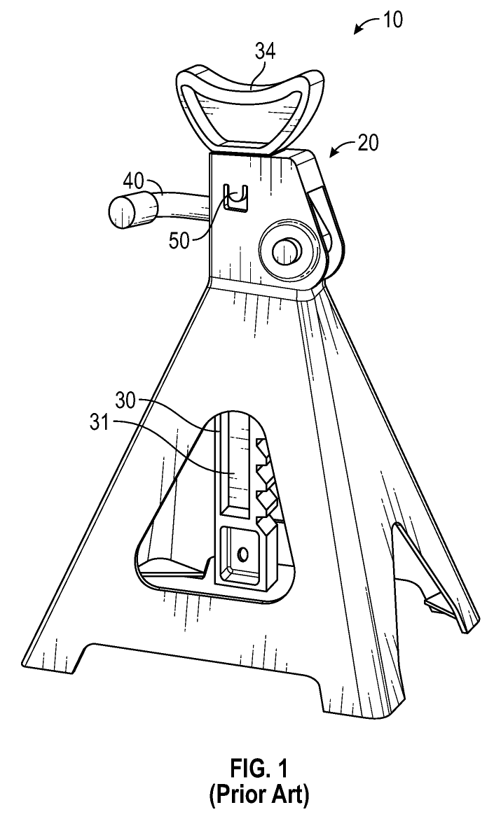

### DETAILED DESCRIPTION

According to various embodiments of the present disclosure, a jack stand is disclosed that includes features and structures that provide advantageous characteristics. Among other things, the jack stand in accordance with various embodiments, employs a knob, rather than a handle to disengage the pawl from the saddle post of the jack stand. Among the advantages that knobs offer is that the use of a knob rather than a handle reduces the chance of the pawl being accidentally dropped both when there is a load on the jack stand and when there is no load on the jack stand. That is, because of the shape of a knob, it normally takes purposeful action (e.g., gripping and turning) by the user to cause the knob to rotate to disengage the pawl from the saddle post. Additionally, when there is load on the jack stand, it is nearly impossible for the knob to be turned because of the amount of force needed to grip and turn the knob. An additional benefit of employing knobs in jack stands rather than handles is that it makes manufacturing of such jack stands simpler and easier.

Further, rather than employing a tab of the base structure that needs to be bent to prevent the saddle post from being accidentally pulled out of the base structure, the jack stand in accordance with some embodiments, employs a stopper post that is inserted through a hole at an upper part of the base structure and into the recess of the saddle post to prevent the saddle post from being accidentally pulled out of the base structure.

In addition, the jack stand in accordance with various embodiments may employ a double lock system to ensure that the saddle post is not accidentally dropped. More specially, and as will be further described herein, the jack stand may employ a locking pin for inserting into one of the plurality of slots on the saddle post of the jack stand to prevent the saddle post from being accidentally dropped. Attached to a first end of the locking pin is a first chain end of a chain, and at the second chain end of the chain is a safety pin to clip or attach to the second end of the locking pin once the locking pin has been inserted through the one of the slots of the saddle post. This ensures that the locking pin is not inadvertently pulled or pushed out of the one of the slots of the saddle post as will be further described herein.

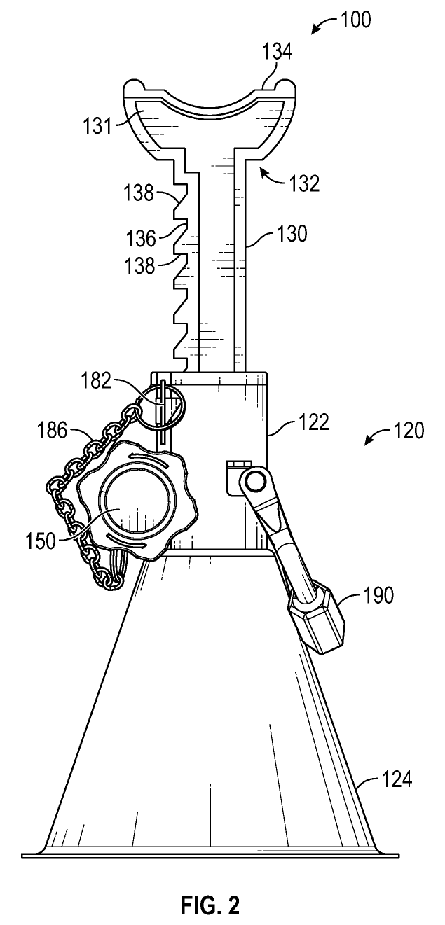

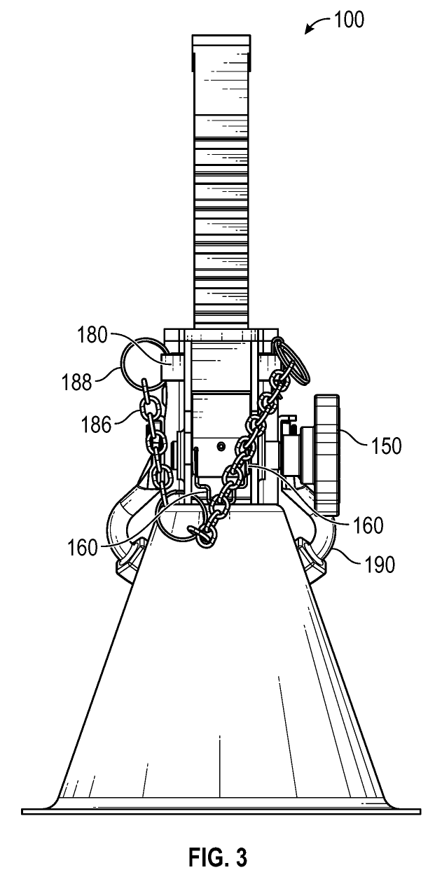

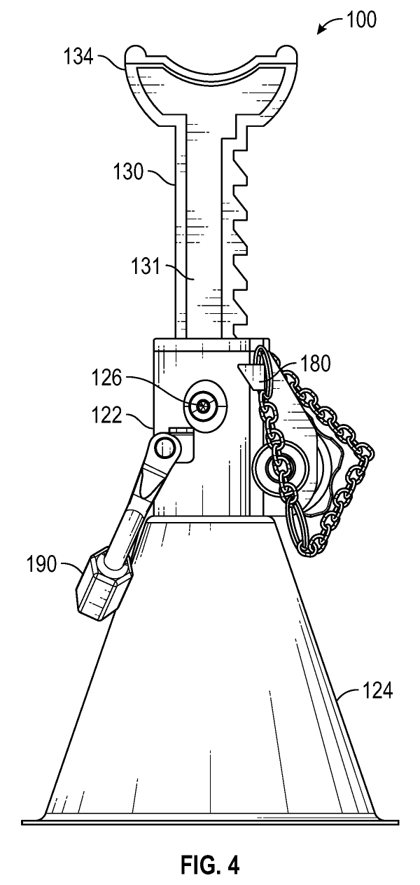

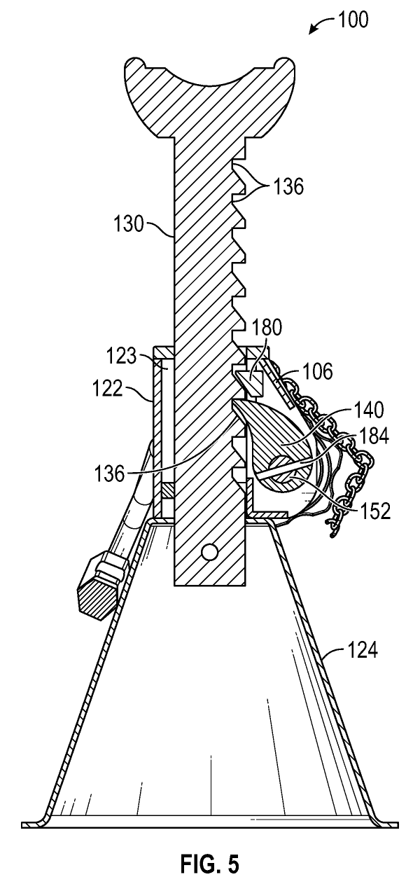

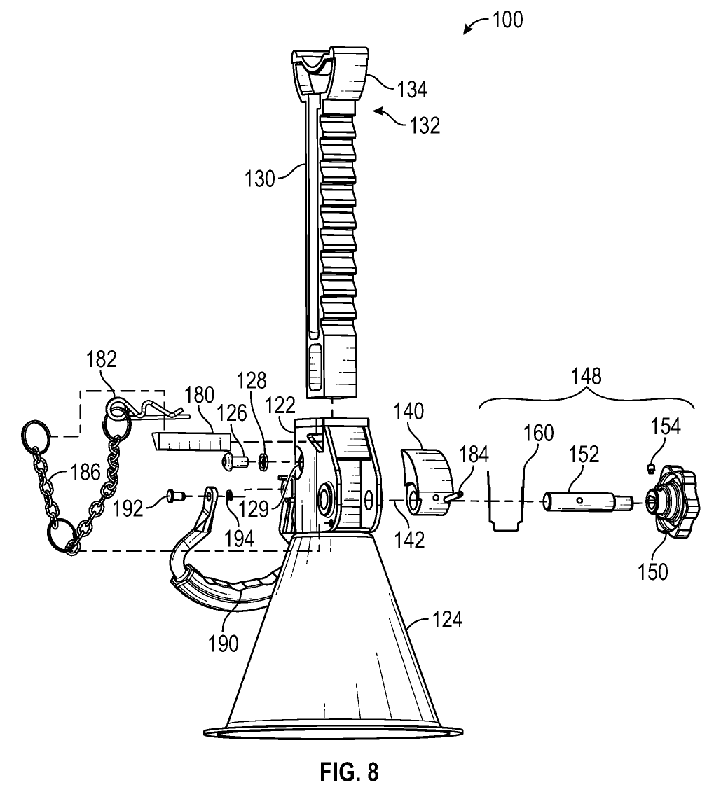

Referring to FIGS. 2-5 and 8 providing different views and perspectives of an example jack stand in accordance with various embodiments. Note that in the following description, the various views of the jack stand 100 will be described using relative terms such as front view, left side view, right side view, and so forth for ease of description and illustrative purposes only are not meant to be limiting in scope. More specifically, FIG. 2 is a right side view of the jack stand 100, FIG. 3 is a front view thereof, FIG. 4 is a left side view thereof, FIG. 5 is a cross-sectional view thereof, and FIG. 8 is an exploded view thereof.

In various embodiments, the jack stand 100 includes a base 120 that may comprise of a top neck portion 122 and a bottom base portion 124, which may have a frustum shape with a flat bottom rim. As illustrated in FIG. 5, which is a cross-sectional view of the jack stand 100, the top neck portion 122 (of the base 120 as shown, for example, in FIG. 2) may include a channel 123 through which at least a portion of an elongated saddle post 130 (herein simply “saddle post 130”) may be movably disposed. At the end 132 of the saddle post 130 that extends out of the base 120 is a saddle 134 (see FIGS. 2 and 4), which may contact a bottom surface of a load, such as the undercarriage of a motor vehicle, when the jack stand 100 is being used to support the weight of the load in a lifted position. In some cases, the saddle 134 and the saddle post 130 may be a single unitary piece made with the same material (e.g., cast iron or steel). Disposed on a first longitudinal side of the saddle post 130 are a plurality of teeth 138, and a plurality of slots 136 disposed between the teeth 138. That is, each slot 136 may be defined by a pair of the teeth 138.

On a second longitudinal side of the saddle post 130 that is orthogonal to the first longitudinal side of the saddle post 130 is a recess 131 that extends lengthwise from at least the top of the saddle post 130 up to the bottom end of the saddle post 130. In embodiments where the saddle post 130 and the saddle 134 are a single unitary piece, the recess 131 may extend from the bottom or near to the bottom of the saddle post 130 to the top or near to the top of the saddle 134 as illustrated in FIG. 8. In some embodiments, there may be a second recess on the opposite longitudinal side of the saddle post 130 that is also orthogonal to the first longitudinal side of the saddle post 130 that includes the teeth 138 and the slots 136.

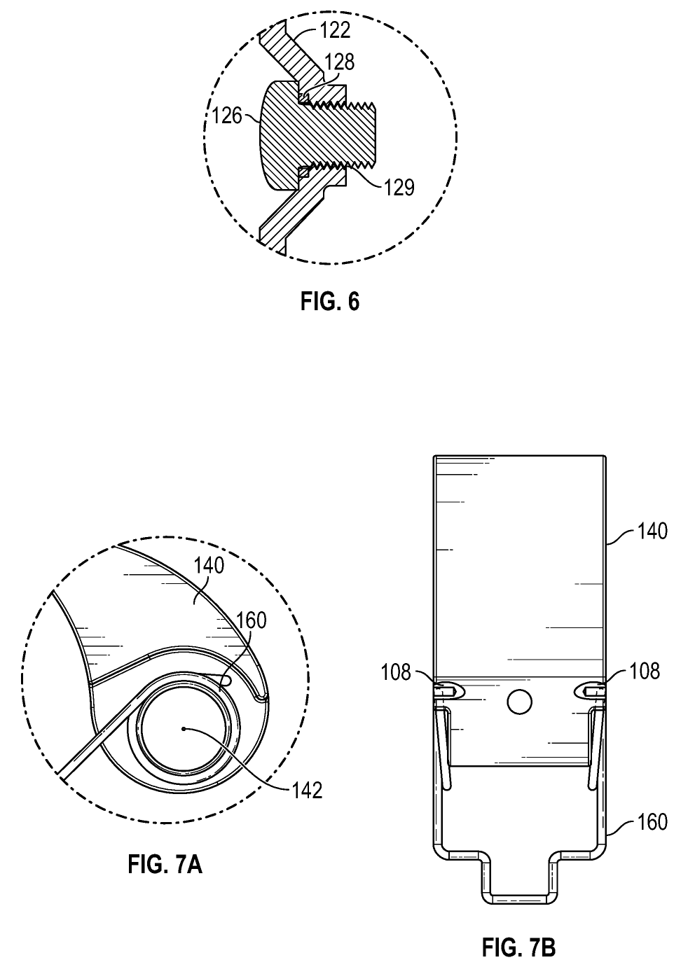

In various embodiments, to prevent the saddle post 130 from being inadvertently pulled out of the base 120, the jack stand 100 includes a stopper post 126 (see, for example, FIGS. 4, 6, and 8), such as a flat head screw, is inserted/disposed through a hole 129 in the top neck portion 122 of the base 120 and into the recess 131 of the saddle post 130. Note that FIG. 6 is a close-up cross-sectional view of the stopper post 126 inserted into a through hole 129 of the top neck portion 122 of the base 120. In some embodiments, disposed between the stopper post 126 and the outside surface of the top neck portion 122 is a washer 128 (see FIGS. 6 and 8), such as an elastic washer (e.g., rubber washer, urethane washer, synthetic rubber washer, and so forth). The stopper post 126 is easier to use in preventing the saddle post 130 from being accidentally pulled out than the tabs 50 incorporated in conventional jack stands since it does not require a large force to insert (e.g., screw in) the stopper post 126 into the hole 129 of the top neck portion 122 and into the recess 131 of the saddle post 130, thus preventing the saddle post 130 from being pulled out of the base 120.

As in conventional jack stands, the jack stand 100 includes a pawl 140 (see, for example, FIGS. 5, 7A, 7B, and 8) to engage with the slots 136 of the saddle post 130. The pawl 140 may be at least partially rotatable around an axis 142 (see, for example, FIG. 7A and 8). Attached to the pawl 140 is a knob assembly 148 as illustrated, for example, in FIG. 8. The knob assembly 148 may include a torsion spring 160, a knob shaft 152, and the knob 150. In various embodiments, the knob 150 may be attached to an end of the knob shaft 152 via a screw 154 or by other attachment means. The knob assembly 148 may extend along or centered along the axis 142 of the pawl 140. For example, the center axis of the knob shaft 152 may correspond to (e.g., may be the same as) the axis 142 of the pawl 140 and the knob shaft 152 may be inserted into the pawl 140 and through/along the axis 142 of the pawl 140. The torsion spring 160, which may be a double torsion spring, has two coils with a center axis that corresponds to the axis 142 of the pawl140. Similarly, the center axis of the knob 150 may correspond to the axis 142 of the pawl 140.

In some embodiments, the knob 150 may be a fluted knob as illustrated, for example, in FIGS. 2 and 8. Alternatively, the knob 150 may be round thumb knob with multiple grooves or a lobe knob. In still other embodiments, the knob 150 a wing knob, a t-handle knob, or a tapered knob. The selection of the type of knob to be employed may be based on a number of factors including whether a knob is easy to grip and turn without being accidentally rotated. Thus, in some cases, a knob with gripping features, such as grooves, and that has a low profile (to avoid accidental rotation), such as a fluted knob, may be desirable in some instances.

In some embodiments, the pawl 140 is connected to the knob shaft 152 via a spring pin 184. In various embodiments, the torsion spring 160, as noted above, may be a double torsion spring with two coils at opposing sides of the torsion spring 160. For the embodiments, the two coils of the torsion spring 160 may wrap or encircle around the knob shaft 152 and may be disposed on opposite lateral sides of the pawl 140. That is, the two coils of the torsion spring 160 may have a common central axis that corresponds to the axis 142 of the pawl 140. The torsion spring 160 also has two opposite ends, the two opposite ends inserted, respectively, into two spring end receiver cavities 108 located on opposite sides of the pawl 140 as illustrated in FIG. 7B, which is top view of the pawl 140 and torsion spring 160 of the example jack stand 100. In contrast to FIG. 7B, FIG. 7A illustrates a close-up view of one of the lateral sides of the pawl 140 including one of the coils of the torsion spring 160 (the other coil being located on the opposite lateral side of the pawl 140 in FIG. 7A). The two coils of the torsion spring 160 are wrapped or encircle around the axis 142 of the pawl 140, as well as the knot shaft 152

In various embodiments, the jack stand 100 may include a locking pin 180 (see FIGS. 3, 5, and 8) that may be inserted through holes of the top neck portion 122 of the base 120 and through one of the slots 136 of the saddle post 130. When inserted into one of the slots 136 of the saddle post 130, the locking pin 180 prevents the saddle post 130 from accidentally being dropped. The locking pin 180, as illustrated in FIG. 8 is an elongated pin, with a triangular cross-section for insertion into a slot 136. To prevent the locking pin 180 from being inadvertently pulled or pushed out of a slot 136, a first end of a chain 186 (via a first buckle 188) may be attached to a first end of the locking pin 180. Attached to a second chain end of the chain 186 (a second buckle 188) is a safety pin 182 (see FIGS. 2 and 8) that may be inserted into or attached to a second end of the locking pin 180 once the locking pin 180 has been inserted through one of the slots 136. That is, to ensure that locking pin 180 is not accidentally pushed or pulled out of a slot 136 of the saddle post 130, a buckle 188 at a first chain end of the chain 186 is attached to a first end of the locking pin 180, and once the locking pin 180 has been inserted through one of slots 136, via a through-hole (not illustrated) in the top neck portion 122, the safety pin 182 attached to the second chain end of the chain 186 is inserted or attached to the second end of the locking pin 180. In some embodiments, the chain 186 may include a third buckle 188 that is attached to the top neck portion 122 of the base 120 (see, for example, FIG. 8 where there is a broken line connecting the third buckle to the top neck portion 122 of the base 120). This ensures that the locking pin 180 and the safety pin 182 are not lost. Note that although in the figures, the buckles 188 are depicted as being rings, in alternative embodiments, one or more of the buckles 188 may one or more of the links of the chain 186.

As noted above, the jack stand 100 includes a handle 190 for lifting or carrying the jack stand 100, but not for operating the pawl 140. The handle 190, in some embodiments, may be attached to the top neck portion 122 of the base 120 via screws 192. In some embodiments, washer 194 may also be employed for attaching the handle 190 to the top neck portion 122. In some embodiments, and as illustrated in FIG. 5, the jack stand 100 may include a positioning plate106 to prevent the pawl140 from over-rotating.

After reviewing the present disclosure, an individual of ordinary skill in the art will immediately appreciate that some details and features can be added, removed and/or changed without deviating from the spirit of the invention. Reference throughout this specification to "one embodiment," "an embodiment," “additional embodiment(s)” or “some embodiments,” means that a particular feature, structure or characteristic described in connection with the embodiment(s) is included in at least one or some embodiment(s), but not necessarily all embodiments, such that the references do not necessarily refer to the same embodiment (s). Furthermore, the particular features, steps, structures, or characteristics may be combined in any suitable manner in one or more embodiments. These and other changes can be made to the embodiments in light of the above- detailed description. In general, in the following claims, the terms used should not be construed to limit the claims to the specific embodiments disclosed in the specification and the claims, but should be construed to include all possible embodiments along with the full scope of equivalents to which such claims are entitled.

1. A Jack stand, comprising:
a base with a channel;
an elongated saddle post at least partially inserted into the channel, the elongated saddle post having at least one slot;
a pawl at least partially rotatable around an axis to engage with the at least one slot of the elongated saddle post; and
a knob assembly attached to the pawl and centered along the axis of the pawl, the knob assembly including a knob and a torsion spring to bias at least a portion of the pawl into the slot.

2. The jack stand of claim 1, wherein the base includes a top neck portion and a bottom base portion with a flat bottom rim, and the channel at least partially in the top neck portion.

3. The jack stand of claim 2, further comprising a locking pin and a chain having a first chain end and a second chain end, the locking pin to insert into a slot of the elongated saddle post via holes of the top neck portion of the base and having a first end and a second end opposite of the first end, the first chain end of the chain attached to the first end of the locking pin and the second chain end of the chain attached to a safety pin to attach to the second end of the locking pin.

4. The jack stand of claim 2, wherein the elongated saddle post includes a recess on a side of the elongated saddle post, the top neck portion of the base includes a hole, and the jack stand further includes a stopper post to insert through the hole and into the recess of the saddle post.

5. The jack stand of claim 4, wherein the stopper post is a screw.

6. The jack stand of claim 1, wherein the elongated saddle post includes a plurality of slots.

7. The jack stand of claim 6, wherein the elongated saddle post includes a plurality of teeth arranged longitudinally along a side of the elongated saddle post, and each of the plurality of slots defined by a pair of teeth of the plurality of teeth.

8. The jack stand of claim 1, wherein the elongated saddle post includes a saddle disposed at an end of the elongated saddle post that extends out of the base.

9. The jack stand of claim 1, wherein the knob assembly includes a knob shaft, the knob shaft inserted through the axis of the pawl and attached to the pawl, and the knob disposed at an end of the knob shaft.

10. The jack stand of claim 9, wherein the torsion spring has a central axis that corresponds to the axis of the pawl and has two opposite ends, the two opposite ends inserted into two spring end receiver cavities located on opposite sides of the pawl.

11. The jack stand of claim 10, wherein the torsion spring is a double torsion spring with two coils that are disposed on the opposite sides of the pawl, and that wrap around the knob shaft.

12. The jack stand of claim 1, wherein the knob is a fluted knob.

13. The jack stand of claim 1, wherein the knob is a round thumb knob with multiple grooves, a lobe knob, a wing knob, a t-handle knob, or a tapered knob.

14. A jack stand assembly, comprising
a saddle post at least partially inserted into a channel of a base, the saddle post having a plurality of slots arranged longitudinally along one side of the saddle post;
a pawl at least partially rotatable around an axis to engage with one of the plurality of slots of the saddle post; and
a knob connected to the pawl through a knob shaft disposed along the axis of the pawl, the knob shaft connecting the knob to the pawl to at least partially rotate the pawl to engage or disengage with the one of the plurality of slots when the knob is rotated.

15. The jack stand assembly of claim 14, further comprising the base, the base includes a top neck portion and a bottom base portion, and the channel of the base at least partially in the top neck portion, and wherein the saddle post includes a recess on a side of the saddle post, the top neck portion of the abase includes a hole, and the jack stand further includes a stopper post to insert through the hole and into the recess.

16. The jack stand assembly of claim 15, wherein the stopper post is a screw.

17. The jack stand assembly of claim 15, further comprising a locking pin and a chain having a first chain end and a second chain end, the locking pin to insert into a slot of the saddle post via holes of the top neck portion of the base and having a first end and a second end opposite of the first end, the first chain end of the chain attached to the first end of the locking pin and the second chain end of the chain attached to a safety pin to attach to the second end of the locking pin.

18. The jack stand assembly of claim 14, further comprising a double torsion spring to bias at least a portion of the pawl to engage with the one of the plurality of slots of the saddle post, the double torsion spring includes two coils that are disposed on opposite sides of the pawl and wrap around the knob shaft.

19. The jack stand assembly of claim 18, wherein the double torsion spring has two opposite ends that are inserted into two spring end receiver cavities located on opposite sides of the pawl.

20. The jack stand assembly of claim 14, wherein the knob is a fluted knob.
.
